(19) United States
(12) Patent Application Publication
(10) Pub. No.: US 2012/0097068 A1
(43) Pub. Date: Apr. 26, 2012

(54) MODIFIED ZNO NANOPARTICLES

(75) Inventors: Richard Riggs, Mannheim (DE); Andrey Karpov, Mannheim (DE); Simon Schambony, Ludwigshafen (DE); Wolfgang Best, Freinsheim (DE)

(73) Assignee: BASE SE, Ludwigshafen (DE)

(21) Appl. No.: 13/379,247

(22) PCT Filed: Jun. 22, 2010
(86) PCT No.: PCT/EP2010/058798

§ 371 Date: Dec. 19, 2011

(30) Foreign Application Priority Data
Jun. 24, 2009 (EP) 09163622.5

(51) Int. Cl. C08K 5/541; C09D 191/06; C07F 3/06; B82Y 30/00

(52) U.S. Cl. 106/270; 556/9; 524/262; 977/773; 977/783

(57) ABSTRACT

Process for the preparation of modified zinc oxide nanoparticles, which comprises reacting zinc oxide nanoparticles, which are dissolved in a solvent, in the presence of ammonia or amines with a tetraalkyl orthosilicate and optionally with an organosilane, with the proviso that the reaction takes place at a content of less than 5% by weight of water, based on the total amount of solvent and water. Modified zinc oxide nanoparticles which have Si—O-alkyl groups and are soluble in organic solvents, obtainable by this process for the preparation. Liquid or solid formulations which comprise modified ZnO nanoparticles. Inanimate organic materials, for example plastics or coatings, which comprise modified ZnO nanoparticles. Method of stabilizing inanimate organic materials against the effect of light, free radicals or heat, where modified ZnO nanoparticles, which optionally comprise UV absorbers and/or stabilizers as further additives, are added to the materials.

The present invention relates to processes for the preparation of modified zinc oxide nanoparticles. The invention further relates to modified zinc oxide nanoparticles. Uses of modified zinc oxide nanoparticles, in particular as UV absorbers, including in the finishing of plastics, are likewise provided by the invention. Further subject matters of the invention are materials which comprise modified zinc oxide nanoparticles which have been prepared by this process or modified zinc oxide nanoparticles, and methods of stabilizing materials by adding modified zinc oxide nanoparticles.

Further embodiments of the present invention can be found in the claims, the description and the examples. It goes without saying that the features specified above and still to be explained below of the subject matter according to the invention can be used not only in the combinations specifically stated in each case, but also in other combinations without departing from the scope of the invention. The embodiments of the present invention in which all of the features have the preferred or very preferred meanings are preferred or very preferred, respectively.

The use of metal oxides such as titanium dioxide (TiO₂) or zinc oxide (ZnO) to protect against UV radiation has already been known from the prior art for a long time. Compared with organic UV absorbers, inorganic UV absorbers, as described in the prior art, have various advantageous technical features, e.g. increased migration stability, high thermal stability or stability to photoinduced degradation. However, the property of the metal oxides, through their photocatalytic activity, to increase the rate of degradation of the matrix surrounding them, for example a polymer matrix, is often disadvantageous. Remedies here can offer, for example, amorphous layers comprising silicon oxides or aluminum oxides which are applied to the UV-absorbing metal oxide particles.

WO 90/06874 A1 describes UV-absorbing chemically inert compositions comprising particles consisting of ZnO with a coating made of, for example, SiO₂ and Al₂O₃. The particles are prepared in an aqueous slurry.

WO 93/22386 A1 describes processes for the preparation of particles which are surrounded by a dense coating made of amorphous silica (SiO₂). In this process, particles suspended in aqueous solution are reacted with alkali metal silicates at a pH of from 7 to 11.

EP 0 998 853 A1 describes metal oxide powders which are surrounded with a tight silica coating of 0.1 to 100 nm. The preparation of the metal oxide powders surrounded with silica takes place in aqueous solution with the help of silicic acids. According to EP 0 998 853 A1, silica-coated TiO₂ particles have reduced photocatalytic activity.

EP 1 167 462 A1 describes metal oxide particles with a silica coating which are furthermore also treated with a hydrophobicizing agent. The silica coating is formed with the help of tetraalkoxysilanes in aqueous solution. The hydrophobicizing agents used are alkylalkoxysilanes.

EP 1 284 277 A1 describes metal oxide particles coated with silicon dioxide and a process for their preparation. EP 1 284 277 A1 furthermore describes the use of these particles in sunscreen compositions, where the coated metal oxide particles have reduced photocatalytic activity compared with metal oxide particles without a coating.

H. Wang, et al. (Chemistry Letters, 2002, 630-631) describe ZnO nanoparticles which are coated with silica with the help of a two-stage procedure. Firstly, a mixture of a tetraethoxysilane, ethanol and aqueous ammonia solution is prepared. ZnO nanoparticles are then added to this solution. The ZnO particles provided with silica coatings of about 20 nm exhibit reduced photocatalytic activity.

WO 03/104319 A1 describes powders comprising ZnO fine particles with a silica coating and thermoplastic resins which comprise such particles. According to WO 03/104319 A1, the coated ZnO particles have reduced photocatalytic activity and also reduced escape of zinc ions.

According to WO 2007/134712 A1, nanoparticles are obtained by reacting precursors with siloxy compounds. The nanoparticles comprise preferably an SiO₂ coating and/or further functionalization, including organofunctional silanes. According to WO 2007/134712 A1, ZnO particles coated with silica have reduced photocatalytic activity.

As a rule, the aforementioned zinc oxide particles modified with silica are prepared in aqueous solution. The modified zinc oxide particles prepared using these processes generally have an inadequate solubility in many organic solvents or hydrophobic polymers. Furthermore, there is a need for modified for ZnO nanoparticles which have a yet further reduced photocatalytic activity compared with the prior art.

It was therefore an object of the present invention to provide modified zinc oxide particles which are readily soluble in organic solvents and hydrophobic polymers. It was a further object of the invention to provide modified zinc oxide particles which have reduced photocatalytic activity.

As is evident from the disclosure of the present invention, these and other objects are achieved through the various embodiments of the process according to the invention and of the zinc oxide nanoparticles (ZnO nanoparticles) which are described below.

Surprisingly, it has been found that these objects are achieved by a process for the preparation of modified ZnO nanoparticles in which
a. zinc oxide nanoparticles, which are dissolved in a solvent, are reacted in the presence of ammonia or amines with
b. a tetraalkyl orthosilicate and
c. optionally with an organosilane
   with the proviso that the reaction takes place at a content of less than 5% by weight of water, based on the total amount of solvent and water.

Within the context of this invention, expressions of the form Cₐ-C_{b} refer to chemical compounds or substituents with a certain number of carbon atoms. The number of carbon atoms can be selected from the entire range from a to b, including a and b, a is at least 1 and b is always greater than a. The chemical compounds or the substituents are further specified by expressions of the form Cₐ-C_{b}-V. V here is a chemical compound class or substituent class, for example alkyl compounds or alkyl substituents.

Specifically, the collective terms specified for the various substituents have the following meaning:

C₁-C₂₀-alkyl: straight-chain or branched hydrocarbon radicals having up to 20 carbon atoms, for example C₁-C₁₀-alkyl or C₁₁-C₂₀-alkyl, preferably C₁-C₁₀-alkyl, for example C₁-C₃-alkyl, such as methyl, ethyl, propyl, isopropyl, or C₄-C₆-alkyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, or C₇-C₁₀-alkyl, such as heptyl, octyl, 2-ethylhexyl, 2,4,4-trimethylpentyl, 1,1,3,3-tetramethylbutyl, nonyl or decyl, and isomers thereof.

Aryl: a mono- to trinuclear aromatic ring system comprising 6 to 14 carbon ring members, e.g. phenyl, naphthyl or anthracenyl, preferably a mono- to binuclear, particularly preferably a mononuclear, aromatic ring system.

C₁-C₂₀-Alkoxy is a straight-chain or branched alkyl group having 1 to 20 carbon atoms (as specified above) which are attached via an oxygen atom (—O—), for example C₁-C₁₀-alkoxy or C₁₁-C₂₀-alkoxy, preferably C₁-C₁₀-alkyloxy, particularly preferably C₁-C₃-alkoxy, such as, for example, methoxy, ethoxy, propoxy.

Within the context of this application “nanoparticles” are understood as meaning particles which have a particle size of from 1 nm to 500 nm.

To determine the particle size of nanoparticles, in particular also of nanoparticulate modified ZnO, the person skilled in the art has available to him a series of different methods which depend on the composition of the particles and can sometimes produce differing results with regard to the particle size. For example, the particle size can be determined by measurements with the help of a transmission electron microscope (TEM), dynamic light scattering (DLS) or measurements of the UV absorption wavelength. Within the context of the present application, particle sizes are determined, if possible, with the help of a TEM or alternatively through measurement of the DLS. For an ideally spherical shape of the nanoparticles, the particle size would correspond to the particle diameter. Of course the agglomerates (secondary particles), possibly forming as a result of a juxtaposition of nanoparticles, of the initially forming primary particles can also be larger than 500 nm. The primary and secondary particles can have different shapes, for example spherical, needle-shaped or else irregular in shape.

The term “zinc oxide nanoparticles” or “ZnO nanoparticles” refers to particles which consist substantially of zinc oxide, it being possible for these particles to also have a certain hydroxide concentration on their surface, depending on the particular environmental conditions, as is known to the person skilled in the art from the prior art (Dissertation, B. Rohe, “Characterization and Applications of uncoated, silane-coated and UV-modified nano-zinc oxides”, Duisburg-Essen University, 2005, pp. 49, 90—Synthesis). The ZnO nanoparticles are therefore sometimes ZnO/zinc hydroxide/zinc oxide hydrate particles. Moreover, it is also possible, for example depending on the preparation, for anions of a zinc salt to be located on the ZnO surface, for example acetate groups in the case of the use of Zn(OAc)₂ or Zn(OAc)₂ dihydrate (cf. Sakohara et al. J. Chem. Eng. Jap. 2001, 34, 15-21; Anderson et al. J. Phys. Chem. B 1998, 102, 10169-10175, Sun et al. J. Sol-Gel Sci. Technol. 2007, 43, 237-243). Being primary particles, the ZnO nanoparticles preferably have a particle diameter of less than 500 nm, particularly preferably of less than 200 nm, in particular of from 10 to 100 nm. ZnO nanoparticles may also be present as agglomerates. The secondary particles generally have particle diameters of from 50 nm to 1000 μm, preferably from 80 nm to 500 μm, in particular from 100 to 1000 nm.

The term “modified zinc oxide nanoparticles” refers to ZnO nanoparticles which interact with a coating comprising silicon and oxygen, for example a coating comprising silicate. Here, the nature of the interaction is fundamentally arbitrary. Preferably, however, the interaction is via a chemical bonding of the coating constituents to the ZnO nanoparticles. Furthermore, it may also be an ionic interaction (Coulomb interaction), an interaction via hydrogen bridge bonds and/or a dipole/dipole interaction. The interaction may of course also be a combination of the aforementioned possibilities. The modified ZnO nanoparticles preferably have a particle diameter of less than 500 nm, very preferably of less than 200 nm and in particular the particle diameter of the modified zinc oxide nanoparticles is from 10 to 100 nm.

Within the context of this invention, the term “solvent” is also used by way of representation for diluents. The compounds dissolved in the solvent are present either in molecularly dissolved form, suspended form, dispersed form or emulsified form in the solvent or in contact with the solvent. Solvents are of course also to be understood as meaning mixtures of solvents.

Within the context of this application, (modified) ZnO nanoparticles “dissolved” in a solvent are understood as meaning particles dispersed or suspended in the solvent.

“Liquid formulations” of the modified ZnO nanoparticles are solutions, dispersions or suspensions of the modified ZnO nanoparticles.

“Solid formulations” of the modified ZnO nanoparticles are solid-phase mixtures comprising modified ZnO nanoparticles, for example dispersions of the modified ZnO nanoparticles in a polymeric matrix, such as, for example, in polymers, oligomeric olefins, waxes, e.g. Luwax®, or in a masterbatch.

Zinc oxide nanoparticles are commercially available or can be prepared by processes known to the person skilled in the art, for example by so-called dry or wet processes. The dry process involves the combustion of metallic zinc. Finely divided zinc oxide is prepared primarily by wet chemical methods by precipitation processes.

Zinc oxide nanoparticles are used in step a. of the process according to the invention and are present in a solvent. In this connection, this is preferably a dispersion or suspension of the zinc oxide nanoparticles in the solvent. Very particularly preferably, the zinc oxide nanoparticles are present in the solvent in suspended form. The zinc oxide nanoparticles can also be produced in situ in the solvent in step a.

The preparation of the solution of zinc oxide nanoparticles is carried out by processes known to the person skilled in the art for the preparation of solutions, dispersions or suspensions of zinc oxide particles in liquids.

The content of zinc oxide nanoparticles in the solution in step a. can, for example depending on the stability of the dispersion or suspension, vary within a wide range. As a rule, from 0.1 to 50% by weight of zinc oxide nanoparticles, based on the amount of solvent, are used. Preference is given to from 1 to 30% by weight of zinc oxide nanoparticles, in particular from 10 to 30% by weight of zinc oxide nanoparticles, based on the amount of solvent.

The solvents used are preferably polar solvents or mixtures thereof. Within the context of the process according to the invention, suitable polar solvents are all solvents with a dielectric constant greater than 10, preferably greater than 15. The polar solvents used are preferably alcohols, ethers, amides, amines. The amines may be either identical to or different from the amines in step a. of the process according to the invention. The solvents used are particularly preferably methanol, ethanol, 1-propanol, 2-propanol, THF, DMF, pyridine or ethanolamine. In particular, suitable polar solvents are methanol, ethanol, 1-propanol, 2-propanol.

In the reaction within the scope of the process according to the invention, the content of water in the solvent is less than 5% by weight of water, based on the total amount of solvent and water. Preferably, the solvent comprises less than 2% by weight of water, particularly preferably less than 1% water. In particular, the working conditions are substantially anhydrous with less than 0.5% by weight of water, in particular less than 0.2% by weight of water.

The amines used in step a. of the process according to the invention are preferably primary amines. Preferred primary amines are amino alcohols such as ethanolamine, propanolamine, ether-containing amines such as 2-methoxyethylamine, 3-methoxypropylamine, polyethylene glycolamine, C₁-C₂₀-alkylamines such as methylamine, butylamine or octadecylamine. Ethanolamine, methylamine or butylamine are very preferred.

Preference is given to using ammonia in step a.

The content of ammonia or amines in the solution in step a. can vary within a wide range, for example depending on the solubility of the ammonia or of the amines. As a rule, from 0.01 to 10 molar equivalents of ammonia or amine, based on the ZnO, are used. Preference is given to from 0.1 to 3 molar equivalents of ammonia or amine, in particular from 0.2 to 2 molar equivalents of ammonia or amine, based on ZnO.

In one preferred embodiment of the process according to the invention, to prepare the solution in step a., the zinc oxide nanoparticles are firstly dissolved in a solvent and then ammonia or amine is introduced in the form of a gas into the solution. Alternatively, the zinc oxide nanoparticles can be dissolved in a solvent into which ammonia or amine has already been introduced. Furthermore, it is also possible to introduce zinc oxide nanoparticles and gaseous ammonia or amine into the solvent simultaneously.

In one preferred embodiment of the process according to the invention, organosilanes are added in step c.

In a further preferred embodiment of the process according to the invention, the zinc oxide nanoparticles and ammonia or amine are dissolved separately independently in a solvent. Preferably, zinc oxide nanoparticles and ammonia or amine are dissolved in the same solvent. To prepare the solution in step a., the solutions of zinc oxide nanoparticles and of ammonia or amine are mixed together by customary methods known to the person skilled in the art for mixing liquids. The mixing can take place here in one step, in individual steps or continuously. Preferably, the solution of the zinc oxide nanoparticles is initially introduced and the solution of the ammonia or amine is added.

Within the context of the process according to the invention, in steps b. and c., tetraalkyl-orthosilicate and optionally organosilane are added to the solution from step a. and the dissolved zinc oxide nanoparticles are reacted in the presence of ammonia or amine with the compounds from step b. and c.

The alkyl groups in the tetraalkyl orthosilicates are, independently of one another, preferably C₁-C₂₀-alkyl groups. In step b. of the process according to the invention, the tetraalkyl orthosilicate used is preferably tetramethyl orthosilicate, tetraethyl orthosilicate, tetrapropyl orthosilicate, or tetrabutyl orthosilicate. Tetramethyl orthosilicate or tetraethyl orthosilicate is very preferably used.

The content of tetraalkyl orthosilicate in the process according to the invention can vary within a very wide range, for example depending on the reactivity of the silicate or the desired coating thickness or density. As a rule, from 0.01 to 1.0 molar equivalents of tetraalkyl orthosilicate, based on ZnO, are used. Preference is given to from 0.05 to 0.5 molar equivalents of tetraalkyl orthosilicate, in particular from 0.1 to 0.3 molar equivalents of tetraalkyl orthosilicate, based on the ZnO.

In step c. of the process according to the invention, the optional organosilanes used are preferably mono-, di-, tri-C₁-C₂₀-alkylsilanes, C₁-C₂₀-alkoxysilanes, C₁-C₂₀-trialkoxy-C₃-C₁₈-alkylsilanes, aminoalkylsilanes, ester-containing silanes or polyalkoxysilanes. In particular, triethoxyoctadecylsilane, triethoxyisooctylsilane, triethoxyisobutylsilane, triethoxypropylsilane, trimethoxyhexadecylsilane, PEG-silane, triethoxymethacryloyl-oxypropylsilane, aminopropylsilane are used. C₁-C₂₀-Trialkoxy-C₃-C₁₈-alkylsilanes are very preferably used. Precondensed oligomeric silanes are also used, for example Dynasilan® 9896 from Evonik.

The content of optional organosilanes in the process according to the invention can vary within a wide range, for example depending on the reactivity of the silane or the desired coating thickness or density. As a rule, from 1 to 50 mol % of organosilane, based on the ZnO, are used. Preference is given to from 2 to 30 mol % of organosilane, in particular from 5 to 20 mol % of organosilane, based on the amount of ZnO.

Tetraalkyl orthosilicates and organosilanes can be added either directly or as solutions to the zinc oxide nanoparticles dissolved in the solvent in the presence of ammonia or amines (step b. and c.). Preferably, the solvent used, if present, is the same solvent as for the zinc oxide nanoparticles and/or the ammonia and the amines.

The order of steps a., b. and optionally c. of the process according to the invention is generally arbitrary.

The addition of the organosilane can take place before, during or after the addition of the tetraalkyl orthosilicate. Preferably, the tetraalkyl orthosilicate is added first and then the organosilane.

In one embodiment of the process according to the invention, the tetraalkyl orthosilicates and the organosilanes are initially introduced in the solvent and then zinc oxide nanoparticles and ammonia or amines are added.

In a further embodiment of the process according to the invention, firstly zinc oxide nanoparticles and ammonia or amines are firstly initially introduced in the solvent and then tetraalkyl orthosilicates and the organosilanes are added.

In a further embodiment of the process according to the invention, zinc oxide nanoparticles, tetraalkyl orthosilicates and organosilanes are firstly initially introduced in the solvent and then ammonia or amines are added.

Within the scope of the process according to the invention, the temperature can vary within a wide range, for example depending on the solvent used. In one preferred embodiment of the process according to the invention, the reaction takes place at a temperature in the range from 0 to 200° C. The reaction preferably takes place at temperatures in the range from 30 to 150° C., in particular from 50 to 100° C.

The pressure is of minor importance for carrying out the process according to the invention. In general, all of the steps are carried out at an external pressure which corresponds to atmospheric pressure (1 atm), but can also be carried out under superatmospheric pressure or a slight subatmospheric pressure.

After the formation of the modified zinc oxide nanoparticles, preferably primary particles are obtained with a size distribution which is substantially monodisperse according to DLS. However, it is also possible for larger agglomerates to occur, depending on the solvent and the concentration used.

After the formation of the modified zinc oxide nanoparticles, after reaction has taken place in an optional further step d., the polar solvent is removed. The removal of the polar solvent can take place by any desired method in which a residue comprising the modified zinc oxide nanoparticles is obtained. The polar solvent is preferably partially or completely removed by distillation, filtration, centrifugation, decantation or spray-drying. Particular preference is given to distillation.

In a further optional step e., the modified zinc oxide nanoparticles are subjected to a drying step. The drying takes place by the methods known to the person skilled in the art, for example through the use of a drying cabinet, if necessary at elevated temperature and/or under subatmospheric pressure.

Preferably, however, after the reaction has taken place, the polar solvent is not removed completely in an optional further step d., but the resulting concentrated solution, dispersion or suspension is further processed directly, for example through incorporation into a wax. This procedure has the advantage that difficulties during the redispersion of the completely separated and/or dried modified zinc oxide nanoparticles are avoided.

In a further embodiment of the process according to the invention, in step a. optionally surface-active substances may be present which increase the stability of the dispersion of the ZnO nanoparticles in the solvent.

Within the scope of the process according to the invention (step a.), the optional surface-active substances used are preferably substances with an HLB value (in accordance with Griffin) of from 0 to 9, in particular from 0.5 to 5. The surface-active substances used are particularly preferably ionic, nonionic, betainic, zwitterionic surfactants, especially anionic surfactants. Surface-active substances are generally commercially available and can of course be used as mixtures.

The amount of surface-active substances can vary within a wide range depending, for example, on the particular solvent. Within the scope of the process according to the invention, preference is given to using 1-100% by weight, particularly preferably 5-60% by weight and in particular 10-30% by weight, of surface-active substances, based on the amount of zinc oxide nanoparticles.

In one embodiment of the process according to the invention, the surface-active substances used are preferably carboxylic acids having 10 to 30 carbon atoms, particularly preferably unsaturated and saturated fatty acids. Very particular preference is given to oleic acid, linoleic acid, linolenic acid, stearic acid, ricinoleic acid, lauric acid, palmitic acid, margaric acid.

The present invention further provides modified zinc oxide nanoparticles which have Si—O-alkyl groups and are soluble in organic solvents, obtainable by reacting
a. zinc oxide nanoparticles, which are dissolved in a solvent, in the presence of ammonia or amines with
b. a tetraalkyl orthosilicate and with
c. optionally an organosilane
with the proviso that the reaction takes place at a content of less than 5% by weight of water, based on the total amount of solvent and water.

Preference is given to those modified zinc oxide nanoparticles in which the reaction takes place at a content of less than 2% by weight of water, particularly preferably less than 1% water. Especially those modified ZnO nanoparticles for which the working conditions are substantially anhydrous at less than 0.5% by weight of water, in particular less than 0.2% by weight of water.

Modified zinc oxide nanoparticles which can be prepared, for example, by the above-described process according to the invention have clear differences in terms of composition compared with the zinc oxide nanoparticles of the prior art. The modified zinc oxide nanoparticles according to the invention comprise Si—O-alkyl groups following their preparation, depending on the tetraalkyl orthosilicate used, for example Si—OCH₃ groups. Preferably, the particles according to the invention have a content of from 0.1 to 50% of the originally present Si—O-alkyl groups. The particles according to the invention particularly preferably have a content of from 1 to 30% of the originally present Si—O-alkyl groups, in particular from 5 to 15%.

Furthermore, the particles according to the invention are also soluble in (nonpolar or polar) organic solvents, preferably in solvents with a dielectric number of from 2 to 50, particularly preferably in solvents with a dielectric number of from 3 to 40, in particular from 10 to 40, whereas the particles of the prior art are insoluble in the solvents.

As already mentioned above, the solubility of the particles according to the invention is also to be understood as meaning a suspension whose particles generally only have a low tendency towards sedimentation and which is generally transparent and scatters visible light only slightly.

Furthermore, the modified zinc oxide nanoparticles according to the invention do not exhibit a dense or crystalline SiO₂ coating as are described in the prior art, for example in EP 1 167 462 A1, EP 1 284 277 A1 or WO 03/104319 A1. Around the core made of zinc oxide, the modified zinc oxide nanoparticles according to the invention have an amorphous coating which, besides SiO₂, also comprises other incompletely reacted or hydrolyzed silicate or silane structures. The precise composition of the coating is not known. Presumably, the inhomogeneity of the coating structure is attributed to an only partial hydrolysis of the tetraalkyl orthosilanes and/or orthosilanes, since only small amounts of water are present during the reaction.

The present invention further provides inanimate organic materials, in particular plastics, coatings or paints, which comprise modified ZnO nanoparticles or modified ZnO nanoparticles prepared according to the invention. Preferably, from 0.001 to 50% by weight of zinc oxide nanoparticles are present, particularly preferably 0.01 to 10% by weight of zinc oxide nanoparticles are present, especially from 0.1 to 5% by weight of zinc oxide nanoparticles are present.

Plastics (polymers) are preferably to be mentioned as inanimate organic materials.

The polymers are preferably polyolefins, in particular polyethylene or polypropylene, polyamides, polyacrylonitriles, polyacrylates, polymethacrylates, polycarbonates, polystyrenes, copolymers of styrene or methylstyrene with dienes and/or acrylic derivatives, acrylonitrile-butadiene-styrenes (ABS), polyvinyl chlorides, polyvinylacetals, polyurethanes, polyureas, epoxy resins or polyesters. Organic polymers may also be copolymers, mixtures or blends of the aforementioned polymers. Particularly preferred polymers are polyolefins, polystyrenes, polyacrylates, polyurethanes, polyureas, epoxy resins, polyamides, in particular polyethylene or polypropylene.

The plastics may be present as any desired moldings. Preferably, the plastics are present in the form of sheets or films. The moldings are preferably plastic films, sheets or bags.

The invention further provides moldings comprising modified zinc oxide nanoparticles according to the invention or prepared according to the invention. Preferably, from 0.001 to 50% by weight of zinc oxide nanoparticles are present, particularly preferably from 0.01 to 10% by weight of zinc oxide nanoparticles are present, in particular from 0.1 to 5% by weight of zinc oxide nanoparticles are present.

The invention further provides the use of moldings according to the invention in agriculture, as packaging material, in particular in cosmetics, or in automobile construction.

Preferably, the modified ZnO nanoparticles absorb light with a wavelength from the range from 400 to 200 nm, very particularly from 370 to 200 nm. As a rule, the absorption of the modified ZnO nanoparticles also extends into the range below 200 nm.

The present invention therefore further provides the use of modified zinc oxide nanoparticles or modified zinc oxide nanoparticles prepared according to the process according to the invention as UV absorbers in inanimate organic materials.

The present invention further provides the use of modified zinc oxide nanoparticles or modified zinc oxide nanoparticles prepared according to the process according to the invention as stabilizers for inanimate organic materials.

The modified zinc oxide nanoparticles or modified zinc oxide nanoparticles prepared according to the process according to the invention are preferably used as UV absorbers or stabilizers if the inanimate organic materials are plastics, coatings or paints. Particular preference is given to plastics. Furthermore, the plastics here are preferably present in the form of sheets or films.

The incorporation of the modified ZnO nanoparticles into inanimate organic materials takes place analogously to known methods for incorporating ZnO nanoparticles into such materials. For example, mention may be made here of the finishing of polymers (plastics) with zinc oxide during an extrusion step or the preparation of solid or liquid cosmetic formulations comprising zinc oxide.

The present invention further provides inanimate organic materials, preferably plastics, coatings or paints, in particular plastics, which comprise further additives besides the modified ZnO nanoparticles according to the invention or prepared according to the invention.

Suitable further additives are, for example, UV absorbers. Further additives are usually used from 0.0001 to 30% by weight, based on the amount of inanimate organic materials. These are preferably used from 0.1 to 10% by weight, based on the amount of inanimate organic material, in particular from 0.1 to 5% by weight. In the case of plastics, coatings or paints, the further additives are to be used according to the customary amounts known to the person skilled in the art.

UV absorbers are often commercial products. They are sold, for example, under the trade name Uvinul® by BASF SE or Tinuvin® by Ciba. The UV absorbers comprise compounds of the following classes: benzophenones, benzotriazoles, cyanoacrylates, cinnamates, para-aminobenzoates, naphthalimides. Moreover, further known chromophores are used, e.g. hydroxyphenyltriazines or oxalanilides. Such compounds are used, for example, on their own or in mixtures with other photoprotective agents in cosmetics applications, for example sunscreen compositions or for stabilizing organic polymers. Further examples of UV absorbers are:

substituted acrylates, such as, for example, ethyl or isooctyl α-cyano-β,β-diphenylacrylate (primarily 2-ethylhexyl α-cyano-β,β-diphenylacrylate), methyl α-methoxycarbonyl-β-phenylacrylate, methyl α-methoxycarbonyl-β-(p-methoxyphenyl)acrylate, methyl or butyl α-cyano-β-methyl-β-(p-methoxyphenyl)acrylate, N-(β-methoxycarbonyl-β-cyanovinyl)-2-methylindoline, octyl p-methoxycinnamate, isopentyl 4-methoxycinnamate, urocanic acid or salts or esters thereof;

derivatives of p-aminobenzoic acid, in particular esters thereof, e.g. ethyl 4-aminobenzoate or ethoxylated ethyl 4-aminobenzoates, salicylates, substituted cinnamic acid esters (cinnamates), such as octyl p-methoxycinnamate or 4-isopentyl 4-methoxycinnamate, 2-phenylbenzimidazole-5-sulfonic acid or its salts,

2-hydroxybenzophenone derivatives, such as, for example, 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone and 4-methoxy-2-hydroxybenzophenone sulfonic acid sodium salt;

esters of 4,4-diphenylbutadiene-1,1-dicarboxylic acid, such as, for example, the bis(2-ethylhexyl) ester;

2-phenylbenzimidazole-4-sulfonic acid and 2-phenylbenzimidazole-5-sulfonic acid or salts thereof;

derivatives of benzoxazoles;

derivatives of benzotriazoles or 2-(2′-hydroxyphenyl)benzotriazoles, such as, for example, 2-(2H-benzotriazol-2-yl)-4-methyl-6-(2-methyl-3-((1,1,3,3-tetramethyl-1-(trimethylsilyloxy)disiloxanyl)propyl)phenol, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)-benzotriazole, 2-(2′-hydroxy-4′-octyloxyphenyl)benzotriazole, 2-(3′,5′-di-tert-amyl-2′-hydroxyphenyl)benzotriazole, 2-[3′,5′-bis(α,α-dimethylbenzyl)-2′-hydroxyphenyl]-benzotriazole, 2-[3′-tert-butyl-2′-hydroxy-5′-(2-octyloxycarbonylethyl)phenyl]-5-chlorobenzotriazole, 2-[3′-tert-butyl-5′-(2-(2-ethylhexyloxy)carbonylethyl)-2′-hydroxyphenyl]-5-chlorobenzotriazole, 2[3′-tert-butyl-2′-hydroxy-5′-(2-methoxycarbonylethyl)-phenyl]-5-chlorobenzotriazole, 2-[3′-tert-butyl-2′-hydroxy-5′-(2-methoxycarbonylethyl)-phenyl]benzotriazole, 2-[3′-tert-butyl-2′-hydroxy-5′-(2-octyloxycarbonylethyl)-phenyl]benzotriazole, 2-[3′-tert-butyl-5′-(2-(2-ethylhexyloxy)carbonylethyl)-2′-hydroxyphenyl]benzotriazole, 2-(3′-dodecyl-2′-hydroxy-5′-methylphenyl)benzotriazole, 2-[3′-tert-butyl-2′-hydroxy-5′-(2-isooctyloxycarbonylethyl)phenyl]benzotriazole, 2,2′-methylenebis[4-(1,1,3,3-tetramethylbutyl)-6-benzotriazol-2-ylphenol], the fully esterified product of 2-[3′-tert-butyl-5′-(2-methoxycarbonylethyl)-2′-hydroxyphenyl]-2H-benzotriazole with polyethylene glycol 300, [R—CH2CH2-COO(CH2)3-]2 where R is 3′-tertbutyl-4-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole;

benzylidenecamphor or its derivatives, as are specified, for example, in DE-A-38 36 630, e.g. 3-benzylidenecamphor, 3-(4′-methylbenzylidene)-dl-camphor;

α-(2-oxoborn-3-ylidene)toluene-4-sulfonic acid or its salts, N,N,N-trimethyl-4-(2-oxoborn-3-ylidenemethyl)anilinium monosulfate;

dibenzoylmethanes, such as, for example, 4-tert-butyl-4′-methoxydibenzoylmethane;

2,4,6-triaryltriazine compounds, such as 2,4,6-tris-{N-[4-(2-ethylhex-1-yl)oxycarbonylphenyl]amino}-1,3,5-triazine, bis(2′-ethylhexyl) 4,4′-((6-(((tertbutyl)aminocarbonyl)phenylamino)-1,3,5-triazine-2,4-diyl)imino)bisbenzoate;

2-(2-hydroxyphenyl)-1,3,5-triazines, such as, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4(2-hydroxy-3-dodecyloxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Further suitable UV absorbers can be found in the publication Cosmetic Legislation, Vol. 1, Cosmetic Products, European Commission 1999, pp. 64-66, to which reference is hereby made.

Moreover, suitable UV absorbers are described in lines 14 to 30 ([0030]) on page 6 of EP 1 191 041 A2. Reference is made to this in its entirety and this reference forms part of the disclosure of the present invention.

According to the invention, inanimate organic materials, in particular polymers (plastics), coatings or paints, which comprise modified ZnO nanoparticles and UV absorbers as further additives can therefore be stabilized against the effect of UV light.

The present invention further provides a method of stabilizing inanimate organic materials, in particular polymers, against the effect of light, free radicals or heat, where modified ZnO nanoparticles, which optionally comprise light-absorbing compounds, for example UV absorbers and/or stabilizers, for example HALS compounds, as further additives, are added to the materials, in particular polymers. Furthermore, in this way it is also possible to stabilize coatings or paints against the effect of light, free radicals or heat.

Suitable further additives, especially if the inanimate organic plastics are polymers, are likewise stabilizers for polymers. The stabilizers are compounds which stabilize organic polymers against degradation upon the action of oxygen, light (visible, infrared and/or ultraviolet light) or heat. They are also referred to as antioxidants, free-radical scavengers or photostabilizers, cf. Ullmann's Encyclopedia of Industrial Chemistry, Vol. 3, 629-650 (ISBN-3-527-30385-5) and EP-A 1 110 999, page 2, line 29 to page 38, line 29. Using such stabilizers it is possible to stabilize virtually all organic polymers, cf. EP-A 1 110 999, page 38, line 30 to page 41, line 35. By virtue of the reference, this passage forms part of the disclosure of the present invention. The stabilizers described in the EP application belong to the compound class of the pyrazolones, the organic phosphites or phosphonites, the sterically hindered phenols and the sterically hindered amines (stabilizers of the so-called HALS type or HALS stabilizers, cf. Römpp, 10th edition, Volume 5, pages 4206-4207.

Suitable further additives are also preferably HALS stabilizers.

HALS stabilizers are often commercial products. They are sold, for example, under the trade name Uvinul® or Tinuvin® by BASF SE. By way of example, mention is to be made of Tinuvin 770 (CAS No. 52829-07-9), Uvinul 4050 H (CAS No. 124172-53-8) or Uvinul 5050 (CAS No. 93924-10-8).

The HALS stabilizers comprise compounds comprising groups of formula II a or those of formula II b,

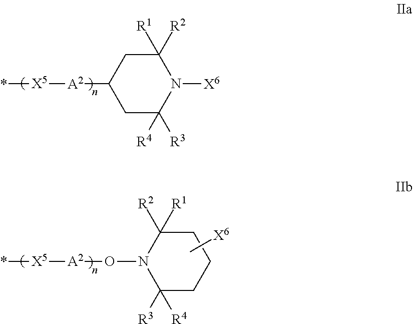

where the variables are defined as follows:
R¹, R², R³ and R⁴ are identical or different and, independently of one another, are C₁-C₁₂-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular R¹, R², R³ and R⁴ are in each case identical and are each methyl,
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl,
X⁵ is an oxygen atom, a sulfur atom, an NH group, an N—(C₁-C₄-alkyl) group, a carbonyl group,
A² is a single bond or a spacer. Examples of spacers A2 are para-phenylene, meta-phenylene, preferably C₁-C₂₀-alkylene, branched or unbranched, where, if appropriate, one to 6 nonadjacent CH₂ groups may each be replaced by a sulfur atom, also oxidized, or an oxygen atom. By way of example, the following spacers may be mentioned:
—CH₂—, —CH₂—CH₂—, —(CH₂)₃—, —(CH₂)₄—, —(CH₂)₅—, —(CH₂)₆—, —(CH₂)₇—, —(CH₂)₆—, —(CH₂)_{g}—, —(CH₂)₁₀—, —(CH₂)₁₂—, —(CH₂)₁₄—, —(CH₂)₁₆—, —(CH₂)₁₈—, —(CH₂)₂₀—, —CH₂—CH(CH₃)—, —CH₂—CH(C₂H₆)—, —CH₂—CH(CH[CH₃]₂)—, —CH₂—CH(n-C₃H₇)—, —[CH(CH₃)]₂—, —CH(CH₃)—CH₂—CH₂—CH(CH₃)—, —CH(CH₃)—CH₂—CH(CH₃)—, —CH₂—C(CH₃)₂—CH₂—, —CH₂—CH(n-C₄H₉)—, —CH₂—CH(iso-C₃H₇)—, —CH₂—CH(tert-C₄H₉)—,
—CH₂—O—, —CH₂—O—CH₂—, —(CH₂)₂—O—(CH₂)₂—, —[(CH₂)₂—O]₂—(CH₂)₂—, —[(CH₂)₂—O]₃—(CH₂)₂—,
—CH₂—S—, —CH₂—S—CH₂—, —(CH₂)₂—S—(CH₂)₂—, —[(CH₂)₂—S]₂—(CH₂)₂—, —[(CH₂)₂—S]₃—(CH₂)₂—, —CH₂—SO—CH₂—, —CH₂—SO₂—CH₂—,
preferred spacers A² are C₂-C₁₀-alkylene groups, branched or unbranched, such as —CH₂—CH₂—, —(CH₂)₃—, —(CH₂)₄—, —(CH₂)₆—, —(CH₂)₆—, —(CH₂)₇—, —(CH₂)₈—, —(CH₂)₉—, —(CH₂)₁₀—,
n is zero or one
X⁶ is hydrogen, oxygen, O—C₁-C₁₉-alkyl, preferably C₁-C₆-alkoxy groups, such as methoxy, ethoxy, n-propoxy, isopropoxy, n-butoxy, isobutoxy, sec-butoxy, tert-butoxy, n-pentoxy, isopentoxy, n-hexoxy and isohexoxy, particularly preferably methoxy or ethoxy
C₁-C₁₂-alkyl, preferably methyl, ethyl, n-propyl, isopropyl, n-butyl, isobutyl, secbutyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C1-C4-alkyl such as methyl, ethyl, n-propyl, isopropyl, n-butyl, isobutyl, sec-butyl and tert-butyl,
C₂-C₁₈-acyl, for example acetyl, propionyl, butyryl, benzoyl, stearyl,
or aryloxycarbonyl having 7 to 12 carbon atoms, for example C₆H₅—OCO.

Examples of particularly highly suitable HALS are
4-amino-2,2,6,6-tetramethylpiperidine,
4-amino-1,2,2,6,6-pentamethylpiperidine,
4-hydroxy-2,2,6,6-tetramethylpiperidine,
4-hydroxy-1,2,2,6,6-pentamethylpiperidine,
4-butylamino-2,2,6,6-tetramethylpiperidine,
4-butylamino-1,2,2,6,6-pentamethylpiperidine,
4-amino-2,2,6,6-tetramethylpiperidine-N-oxyl,
4-hydroxy-2,2,6,6-tetramethylpiperidine-N-oxyl,
4-butylamino-2,2,6,6-tetramethylpiperidine-N-oxyl,
4-hydroxy-2,2,6,6-tetramethyl-1-oxytoxypiperidine,
4-amino-2,2,6,6-tetramethyl-1-oxytoxypiperidine,
4-butylamino-2,2,6,6-tetramethyl-1-octoxypiperidine,
4-acetoxy-2,2,6,6-tetramethylpiperidine,
4-stearyloxy-2,2,6,6-tetramethylpiperidine,
4-aryloyloxy-2,2,6,6-tetramethylpiperidine,
4-methoxy-2,2,6,6-tetramethylpiperidine,
4-benzoyloxy-2,2,6,6-tetramethylpiperidine,
4-cyclohexyloxy-2,2,6,6-tetramethylpiperidine,
4-phenoxy-2,2,6,6-6-tetramethylpiperidine,
4-benzoxy-2,2,6,6-tetramethylpiperidine, and
4-(phenylcarbamoyloxy)-2,2,6,6-tetramethylpiperidine.

Likewise preferred HALS are:
bis(2,2,6,6-tetramethyl-4-piperidyl) oxalate,
bis(2,2,6,6-tetramethyl-4-piperidyl) succinate,
bis(2,2,6,6-tetramethyl-4-piperidyl) malonate,
bis(2,2,6,6-tetramethyl-4-piperidyl) adipate,
bis(1,2,2,6,6-pentamethylpiperidyl) sebacate,
bis(2,2,6,6-tetramethyl-4-piperidyl) terephthalate,
1,2-bis(2,2,6,6-tetramethyl-4-piperidyloxy)ethane,
bis(2,2,6,6-tetramethyl-4-piperidyl)hexamethylene 1,6-dicarbamate,
bis(1-methyl-2,2,6,6-tetramethyl-4-piperidyl) adipate, and
tris(2,2,6,6-tetramethyl-4-piperidyl)benzene 1,3,5-tricarboxylate.

Moreover, preference is given to relatively high molecular weight piperidine derivatives, e.g. the polymer of dimethyl butanedioate and 4-hydroxy-2,2,6,6-tetramethyl-1-piperidineethanol or poly-6-(1,1,3,3-tetramethylbutyl)amino-1,3,5-triazine-2,4-diyl(2,2,6,6-tetramethyl-4-piperidinyl)imino-1,6-hexanediyl(2,2,6,6-tetramethyl-4-piperidinyl)imino, and polycondensates of dimethyl succinate and 1-(2-hydroxyethyl)-4-hydroxy-2,2,6,6-tetramethylpiperidine, which, such as bis(2,2,6,6-tetramethyl-4-piperidyl)sebacate, are particularly highly suitable.

Very particularly highly suitable are 4-amino-2,2,6,6-tetramethylpiperidine, 4-amino-1,2,2,6,6-pentamethylpiperidine, 4-hydroxy-2,2,6,6-tetramethylpiperidine, 4-hydroxy-1,2,2,6,6-pentamethylpiperidine, 4-amino-2,2,6,6-tetramethylpiperidine-N-oxyl and 4-hydroxy-2,2,6,6-tetramethylpiperidine-N-oxyl.

Suitable further effect substances are also auxiliaries for polymers. Auxiliaries are to be understood as meaning, for example, substances which at least largely prevent the fogging of films or moldings made of plastics, so-called antifogging agents. Moreover suitable as polymer additives are antifogging agents for organic polymers from which in particular sheets or films are prepared. Such polymer additives are described, for example, by F. Wylin, in Plastics Additives Handbook, 5th Edition, Hanser, ISBN 1-56990-295-X, pages 609-626. According to the invention, therefore, modified ZnO nanoparticles which comprise auxiliaries as further effect substances can be used as antifogging agents.

Further suitable auxiliaries are lubricants such as oxidized polyethylene waxes and antistats for organic polymers. For examples of antistats cf. the aforementioned reference F. Wylin, Plastics Additives Handbook, pages 627-645.

Suitable further additives are flame retardants, which are described, for example, in Römpp, 10^{th} edition, pages 1352 and 1353, and also in Ullmann's Encyclopedia of Industrial Chemistry, Vol. 14, 53-71. According to the invention, therefore, modified ZnO nanoparticles which comprise flame retardants as further effect substances can be used as flame retardants for polymers.

Standard commercial stabilizers and auxiliaries are sold, for example, under the trade names Uvinul®, Tinuvin®, Chimassorb®, and Irganox® from BASF or Ciba, Cyasorb® and Cyanox® from Cytec, Lowilite®, Lowinox®, Anox®, Alkanox®, Ultranox® and Weston® from Chemtura and Hostavin® and Hostanox® from Clariant. Stabilizers and auxiliaries are described, for example, in Plastics Additives Handbook, 5^{th} edition, Hanser Verlag, ISBN 1-56990-295-X.

Other further additives are organic dyes which absorb light in the visible region, or optical lighteners. Such dyes and optical tighteners are described in detail, for example, in WO 99/40123, page 10, line 14 to page 25, line 25, to which reference is expressly made here. Whereas organic dyes have an absorption maximum in the wavelength range from 400 to 850 nm, optical lighteners have one or more absorption maxima in the range from 250 to 400 nm. As is known, optical lighteners emit fluorescent radiation in the visible range upon irradiation with UV light. Examples of optical lighteners are compounds from the classes of the bisstyrylbenzenes, stilbenes, benzoxazoles, coumarins, pyrenes and naphthalenes. Standard commercial optical lighteners are sold under the names Tinopal®, Uvitex®, Ultraphor® (BASF SE) and Blankophor® (Bayer). Moreover, optical lighteners are described in Römpp, 10^{th} edition, Volume 4, 3028-3029 (1998) and in Ullmann's Encyclopedia of Industrial Chemistry, Vol. 24, 363-386 (2003). According to the invention, therefore, modified ZnO nanoparticles which comprise organic dyes or lighteners as further effect substances can be used for the coloring or lightening of polymers.

Suitable further additives are IR dyes, which are sold, for example, by BASF SE as Lumogen® IR. Lumogen® dyes comprise compounds of the classes of perylenes, naphthalimides, or quaterylenes.

The modified ZnO nanoparticles according to the invention can of course be subsequently further modified on their surface using methods known from the prior art.

The present invention further provides liquid formulations comprising modified ZnO nanoparticles or modified ZnO nanoparticles prepared according to the invention.

The liquid formulations according to the invention or the solutions prepared according to the invention, in particular dispersions or suspensions, can be used directly as they are or following concentration or dilution. Moreover, the liquid formulations according to the invention can also comprise customary additives (additives), e.g. additives which change the viscosity (thickeners), antifoams, bactericides, antifreezes and/or protective colloids. The protective colloids may either be anionic, nonionic, cationic, or zwitterionic in nature.

In addition, the liquid formulations according to the invention or the suspensions prepared according to the invention can be formulated using conventional binders, for example aqueous polymer dispersions, water-soluble resins or with waxes.

The modified ZnO nanoparticles according to the invention are present in the liquid formulations and can also be obtained in powder form from these liquid formulations by removing the volatile constituents of the liquid phase. In the powder, the particles according to the invention may be present individually, in agglomerated form, or else partially in film form. The powders according to the invention here are accessible, for example, by evaporating the liquid phase, freeze-drying or by spray-drying.

Liquid formulations according to the invention are often accessible by redispersing the powders according to the invention, for example in a nonpolar solvent.

The present invention further provides solid formulations comprising modified ZnO nanoparticles or modified ZnO nanoparticles prepared according to the invention.

Solid formulations according to the invention comprise the modified ZnO nanoparticles in differing concentration depending on the application. As a rule, the fraction of the modified ZnO nanoparticles is in the range from 0.1 to 80% by weight and in particular in the range from 0.5 to 50% by weight, based on the total weight of the solid formulation.

For example, the solid formulations are a mixture of the modified ZnO nanoparticles according to the invention in a polymeric carrier material, e.g. polyolefins (e.g. polyethylene of low or high density, polypropylene), styrene homopolymers or copolymers, polymers of chlorinated alkenes (e.g. polyvinyl chloride), polyamides, polyesters (e.g. polyethylene terephthalate or polybutylene terephthalate), polycarbonates or polyurethanes.

Solid formulations according to the invention are also mixtures of the modified ZnO nanoparticles with relatively low molecular weight matrices, e.g. polyethylene waxes.

To prepare the solid formulation, the modified ZnO nanoparticles can be introduced into the molten matrix for example by dispersion at elevated temperature, with the solid formulation being formed during cooling.

If appropriate, the solid formulation can also comprise auxiliaries which improve the distribution of the modified ZnO nanoparticles in the solid matrix (dispersants). For example, waxes can be used for this purpose.

The solid formulations can be used in undiluted form or following dilution to the use concentration.

Solid formulations are, for example, the formulations obtained after removing the volatile constituents of the liquid formulations described above. These are generally mixtures/dispersions of modified ZnO nanoparticles with/in polymers or oligomers (in the masterbatch, in waxes, e.g. Luwax® from BASF SE), which are present as powders or waxes.

The modified ZnO nanoparticles according to the invention in the form of their solid or liquid formulations or powders are preferably used for the finishing, for example for the stabilization, in particular against UV radiation, of organic polymers. For this purpose, the particles can be incorporated into the organic polymers either as solid or liquid formulation, or else as powder by customary methods. Mention is to be made here, for example, of the mixing of the particles with the organic polymers before or during an extrusion step.

Organic polymers are to be understood here as meaning any desired plastics, preferably thermoplastics, in particular films, fibers or moldings of any desired shape. Within the context of this application, these are also referred to simply as organic polymers. Further examples of the finishing or stabilization of organic polymers with polymer additives can be found in the Plastics Additives Handbook, 5^{th} edition, Hanser Verlag, ISBN 1-56990-295-X. The organic polymers are preferably polyolefins, in particular polyethylene or polypropylene, polyamides, polyacrylonitriles, polyacrylates, polymethacrylates, polycarbonates, polystyrenes, copolymers of styrene or methylstyrene with dienes and/or acrylic derivatives, acrylonitrile-butadiene-styrenes (ABS), polyvinyl chlorides, polyvinyl acetals, polyurethanes or polyesters. Organic polymers may also be copolymers, mixtures or blends of the aforementioned polymers. Particularly preferred polymers are polyolefins, in particular polyethylene or polypropylene.

In order to stabilize a thermoplastic polymer against the effect of UV, the procedure may, for example, involve firstly melting the polymer in an extruder, incorporating a particle powder prepared according to the invention and comprising modified ZnO nanoparticles into the polymer melt at a temperature of, for example, 180 to 200° C. (polyethylene) or, for example, about 280° C. (polycarbonate) and preparing granules therefrom, from which films, fibers or moldings which are stabilized against the effect of UV radiation are then produced by known methods.

The amount of modified ZnO nanoparticles in the organic polymer which suffices for stabilizing the polymer can vary, for example over a wide range depending on the intended use. Preferably, the stabilized polymers comprise from 0.1 to 10% by weight of the modified ZnO nanoparticles, based on the total weight of the mixture. Very particularly preferably from 0.5 to 5.0% by weight.

The preparation process of the modified ZnO nanoparticles according to the invention permits a very efficient and controlled access to the particles. The modified ZnO nanoparticles according to the invention are present, for example, as constituents of liquid formulations or of powders and can be readily incorporated into organic polymers. The modified ZnO nanoparticles according to the invention exhibit reduced photocatalytic activity in organic polymers and thus avoid undesired premature degradation of the polymer matrix.

The modified ZnO nanoparticles according to the invention are particularly suitable for the finishing of organic polymers against the effect of UV rays or light.

The examples below are intended to illustrate the invention, but without limiting it.

### EXAMPLES

### Abbreviations

1 eq.=1 molar equivalent

General Procedure for the Preparation of Zinc Oxide—“10 nm Particles” (“10 nm”):

78.8 g of zinc acetate dihydrate were initially introduced into ca. 2 l of isopropanol. The suspension was heated to 75° C. with stirring. 30.29 g of potassium hydroxide were dissolved in 1 l of isopropanol and heated to 75° C. The potassium hydroxide solution was added to the suspension. The suspension was stirred at 75° C. for ca. 1 hour.

The suspension was cooled and the reaction product settled out overnight. The supernatant solvent was drawn off with suction and the residue was washed with 1 l of isopropanol. The residue was washed a total of three times with isopropanol.

The nanoparticulate (10 nm diameter) zinc oxide was stored as suspension in isopropanol.

General Procedure for the Preparation of Zinc Oxide—“90 nm Particles” (“90 nm”):

135 g of zinc acetate dihydrate were initially introduced in ca. 205 ml of methanol. The suspension was heated to 50° C. with stirring. 58.9 g of potassium hydroxide were dissolved in 205 ml of methanol and heated to 50° C. The potassium hydroxide solution was added to the suspension. The suspension was stirred at 50° C. for ca. 5 hours.

The suspension was cooled and the reaction product settled out overnight. The supernatant solvent was drawn off with suction and the residue was washed with 1 l of methanol. The residue was washed a total of three times with methanol. The nanoparticulate (ca. 90 nm diameter) zinc oxide was stored as a suspension in methanol.

General Procedure for Incorporation into Luwax®:

0.9 g of Luwax® A (ethylene homopolymer, BASF SE) were suspended in 30 ml of toluene. (Modified) ZnO (in solution, comprises 0.1 g of ZnO) was then added to the Luwax solution and dissolved on a rotary evaporator at 75° C. (without vacuum) until a homogeneous dispersion was formed. Then, at 75° C./1 mbar, the solvent was drawn off. This gave a homogeneous, colorless wax.

Incorporation into other waxes was carried out analogously.

Incorporation: 10% by weight based on the ZnO nanoparticles.

### Comparative Example 1

1 g of potassium hydroxide (1.6 eq., based on Zn) were dissolved in ethanol to give a 6% strength by weight solution. 1 g of dried zinc oxide (1 eq., “10 nm”) were then added and suspended in toluene. 5.1 g of octadecyltriethoxysilane (1 eq., based on Zn) were then added and heated to reflux temperature. After 3 h at this temperature, a homogeneous, slightly cloudy, yellowish solution was formed. After cooling, the modified zinc oxide was precipitated out with methanol. The precipitate was then removed by centrifugation and washed with methanol. The residue was dried in a vacuum drying cabinet.

Some of the solid was incorporated into Luwax® EVA 1 (see incorporation into Luwax®).

### Comparative Example 2

43.48 g of zinc oxide suspension (ca. 2.5% strength by weight in isopropanol; 1 eq. of ZnO, “10 nm”) and 2.52 ml of aqueous ammonia solution (3 eq. of NH₃, based on ZnO; 25% strength ammonia solution was used) were initially introduced and heated to 50° C. with stirring. 0.77 g of octadecyltriethoxysilane (0.15 eq., based on ZnO) were then added. The suspension was stirred for 5 h at 50° C. Following conclusion of the reaction, some of the suspension was incorporated into Luwax® A (see incorporation into Luwax®).

### Comparative Example 3

21.9 g of zinc acetate dihydrate (1 eq.) were initially introduced at 35% strength in methanol and heated to 50° C. 11.2 g of potassium hydroxide (2 eq., based on Zn) were dissolved in 24% strength in methanol at 50° C. This solution was added to the zinc acetate suspension and after stirred for 30 min. 0.68 g of tetramethyl orthosilicate (0.045 eq. based on Zn), dissolved to 5% strength in methanol were then added and stirred for 1 h at 50° C. 6.37 g of octadecyltriethoxysilane (0.15 eq. based on ZnO) were added to this suspension and the mixture was kept at this temperature for a further 5 h. At the end of the reaction, the precipitated-out precipitate was allowed to settle and the supernatant methanol was filtered off with suction. This operation of settling and suction filtration was repeated two more times. The residue was dissolved in dichloromethane. This gave a stable homogeneous suspension. Some of the suspension was incorporated into Luwax® A (see incorporation into Luwax®).

Analysis: Elemental analysis yielded in the dried product a content of 69% by weight of zinc. This corresponded to 86% by weight of ZnO.

### Comparative Experiment 4

0.718 g of zinc oxide as suspension (ca. 2.5% strength by weight in isopropanol; 1 eq. of ZnO, “10 nm”) and 1.81 ml of aqueous ammonia solution (3 eq. of NH₃; 25% strength ammonia solution was used) were initially introduced and heated to 50° C. with stirring. 0.27 g of tetramethyl orthosilicate (0.2 eq., based on ZnO) were then added. The suspension was stirred for 1 h at 50° C. At the end of the reaction, some of the suspension was incorporated into Luwax® A (see incorporation into Luwax®).

For the elemental analysis, some of the suspension was centrifuged and washed three times with isopropanol. The white residue was then dried in a vacuum drying cabinet.

### Comparative Experiment 5

0.5 g of zinc oxide as suspension (ca. 2.5% strength by weight in isopropanol; 1 equivalent of ZnO, “10 nm”) and 2.65 ml of methanolic ammonia (3 eq. of NH₃; a 7N ammonia solution was used) were heated to 50° C. with stirring and then kept at this temperature for a further 15 min. This produced a cloudy, but homogeneous solution. Some of the solution was incorporated into Luwax® A (see incorporation into Luwax®).

### Example 1

1 g of zinc oxide as suspension (ca. 2.5% strength by weight in isopropanol; 1 eq. of ZnO, “10 nm”) and 5.29 ml of methanolic ammonia (3 eq. of NH₃ based on ZnO; a 7N ammonia solution was used) were initially introduced and heated to 50° C. with stirring. 0.77 g of octadecyltriethoxysilane (0.15 eq., based on ZnO) was then added. The transparent solution was stirred at 50° C. for 5 h. At the end of the reaction, the excess ammonia and the methanol were removed on a rotary evaporator. Some of the suspension was incorporated into Luwax® A (see incorporation into Luwax®).

### Examples 2 to 5

### Variation in the Amount of Tetraalkyl Orthosilicate

1 g of zinc oxide as suspension (ca. 2.5% strength by weight in isopropanol; 1 eq. of ZnO, “10 nm”) and 5.29 ml of methanolic ammonia (3 eq of NH₃; a 7N ammonia solution was used) were initially introduced and heated to 50° C. with stirring. Subsequently, x g of tetramethyl orthosilicate (y eq. based on ZnO) and then 0.77 g of octadecyltriethoxysilane (0.15 eq. based on ZnO) was added. The transparent solution was stirred at 50° C. for 5 h. At the end of the reaction, the excess ammonia and the methanol were removed on a rotary evaporator. Some of the solution was incorporated into Luwax® A (see incorporation into Luwax®).

Example 2: x=0.094, y=0.05; Example 3: x=0.188, y=0.1; Example 4: x=0.376, y=0.2; Example 5: x=0.94, y=0.5.

### Examples 6 to 9

### Variation of the Organosilane

1 g of zinc oxide as suspension (ca. 2.5% strength by weight in isopropanol; 1 eq. of ZnO, “10 nm”) and 5.29 ml of methanolic ammonia (3 eq. of NH₃, based on ZnO; a 7N ammonia solution was used) were initially introduced and heated to 50° C. with stirring. 0.188 g of tetramethyl orthosilicate (0.1 eq based on ZnO) and then the organosilane (0.15 eq. based on ZnO) were then added. The resulting transparent solution was stirred at 50° C. for 5 h. At the end of the reaction, the excess ammonia and the methanol were removed using a rotary evaporator. Some of the solution was incorporated into Luwax® A (see incorporation into Luwax®).

Example 6: Triethoxyisobutylsilane; Example 7: Triethoxypropylsilane; Example 8: Triethoxyhexadecylsilane; Example 9: Dynasilan® 9896 (Evonik)

### Examples 10 and 11

### Variation in the Amount of Tetraalkyl Orthosilicate

1 g of zinc oxide as suspension (ca. 2.5% strength by weight in isopropanol; 1 eq. of ZnO, “10 nm”) and 5.29 ml of methanolic ammonia (3 eq. of NH₃ based on ZnO; a 7N ammonia solution was used) were initially introduced and heated to 50° C. with stirring. x g of tetramethyl orthosilicate (y eq. based on ZnO) and then 0.972 g of 2-[methoxy(polyethyleneoxy)propyl]trimethoxysilane (0.15 eq. based on ZnO) were then added. The transparent solution was stirred at 50° C. for 20 h. Some of the solution was incorporated into Luwax® A (see incorporation into Luwax®).

Example 10: x=0.188, y=0.1; Example 11: x=0.376, y=0.2.

### Example 12

### Ethanolamine

0.375 g of ethanolamine (0.5 eq. based on ZnO) were initially introduced into isopropanol and 1 g of ZnO suspension (ca. 2.5% strength by weight in isopropanol; 1 eq. of ZnO, “10 nm”) were added. The mixture was then heated to 50° C. and this temperature was maintained for a period of 20 h. At the end of the reaction time, 0.94 g of tetramethyl orthosilicate (0.5 eq. based on ZnO) was added to the transparent solution and the reaction solution was maintained at 50° C. for a further 5 h. Some of the solution was incorporated into Luwax® A (see incorporation into Luwax®).

### Example 13

The solubility of the modified zinc oxide nanoparticles of Examples 1 to 12 prepared according to the invention in organic solvents, for example dichloromethane, toluene, isopropanol or mixtures of these is good whereas the noninventive zinc oxide nanoparticles prepared analogously with aqueous ammonia solution are insoluble in these solvents.

### Example 14

Lupolen® is the trade name for a polyethylene (LDPE) from Basell. The Luwax® preparations in the examples and comparative examples were incorporated into Lupolen® by means of a mini extruder and processed to give a film 100 μm in thickness. The concentration was 1% by weight of ZnO based on the total amount of wax and polyethylene. Following the incorporation, the films were illuminated (artificial sunlight) and the UV absorption spectra were measured. The transmission was determined as a measure of the transparency of the films. A reduction in the transparency as a result of the illumination takes place on the basis of the photocatalytic effect of the ZnO, which follows a decomposition of the polymer matrix. The higher the transmission remains during illumination, the less photocatalytically active the ZnO present.

Solasorb® UV200 from Croda (ZnO, as UV absorber for plastics, dispersion with 60% by weight solids content), and Maxlight ZS® from Showa Denko (SiO₂-coated 30 nm ZnO particles) were likewise measured for comparison.

### Stability Comparison: UV Illumination

| Product | | | | | | | | | | |
|---|---|---|---|---|---|---|---|---|---|---|
| from | Transmission (%) at 450 nm after certain illumination times | | | | | | | | | |
| Example | Start - no | 4 | 7 | 10 | 14 | 24 | 28 | 38 | 48 | 63 |
| No. | illumination | days | days | days | days | days | days | days | days | days |
| Comp. 1 | 89 | — | 77 | — | 64 | — | — | — | — | — |
| Comp. 2 | 83 | 50 | — | — | — | — | — | — | — | — |
| Comp. 3 | 87 | — | 43 | — | — | — | — | — | — | — |
| Comp. 4 | 91 | 86 | — | — | — | — | — | — | — | — |
| Comp. 5 | 86 | — | — | 33 | — | — | — | — | — | — |
| Maxlight | 56 | — | — | — | 66 | 64 | — | 63 | — | — |
| ZS ® | | | | | | | | | | |
| Solasorb ® | 79 | — | — | — | 33 | — | — | — | — | — |
| UV200, | | | | | | | | | | |
| 1 | 86 | 86 | — | — | — | 49 | — | — | — | — |
| 2 | 86 | — | — | — | 86 | — | — | — | 85 | — |
| 3 | 87 | — | — | — | 87 | — | — | — | 87 | — |
| 4 | 91 | — | 90 | — | 90 | — | 89 | 89 | 89 | 87 |
| 5 | 88 | — | — | — | 88 | — | 88 | — | 87 | — |
| 12 | 82 | 84 | — | — | — | 83 | — | — | — | — |

The invention is illustrated in more detail by figures without the figures limiting the subject matter of the invention.

These show:

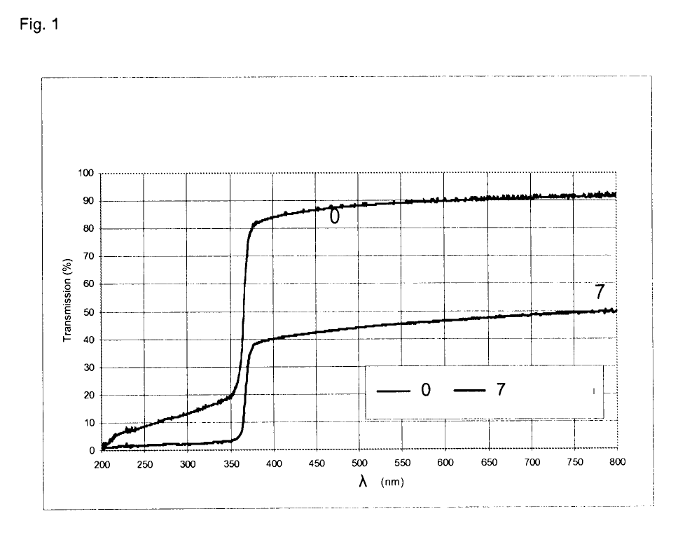

FIG. 1 the measured relative transmission as a function of the wavelength (λ) from 200 to 800 nm for comparative experiment 3.

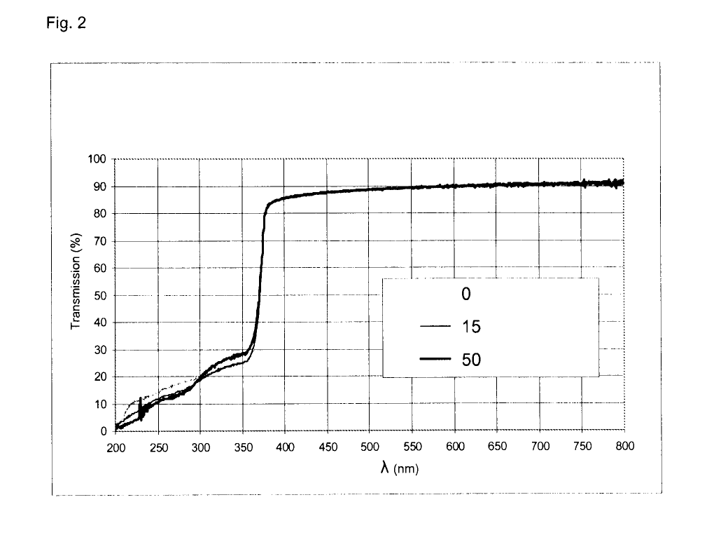

FIG. 2 the measured relative transmission as a function of the wavelength (λ) from 200 to 800 nm for example 3.

FIGS. 1 and 2 show transmission spectra recorded for the films of comparative experiment 3 and for example 3. The results show that for the comparative experiment 3 (FIG. 1) the transmission in the wavelength range from ca. 350 to 800 nm has decreased even after 7 days (curve: 7) considerably compared with the starting situation (curve: 0) since the film becomes cloudy as a result of the decomposition of the polymer matrix, whereas for the film in example 3 (FIG. 2), no change compared with the starting situation is observed after 15 days (curve: 15) and also after 50 days (curve: 50).

1. A process for preparing a modified zinc oxide nanoparticle, comprising:
reacting a zinc oxide nanoparticle dissolved in a solvent with a tetraalkyl orthosilicate, in the presence of ammonia or an amine,
wherein a water content of a reaction mixture for reacting the zinc oxide nanoparticle is less than 5% by weight, based on a total amount of solvent and water.

2. The process of claim 1, wherein the reaction mixture substantially excludes water.

3. The process of claim 1, wherein reacting the zinc oxide nanoparticle and the tetraalkyl orthosilicate comprises reacting with an organosilane.

4. The process of claim 3, comprising:
combining the zinc oxide nanoparticles and the tetraalkyl orthosilicate and subsequently adding the organosilane.

5. The process of claim 1, wherein the zinc oxide nanoparticle is suspended in a polar solvent.

6. The process of claim 1, wherein the zinc oxide nanoparticle is dissolved in the solvent in the presence of a primary amines amine.

7. The process of claim 1, comprising mixing a zinc oxide nanoparticle with a solution comprising ammonia or an amine to obtain a suspension, prior to reacting the zinc oxide nanoparticle with tetraalkyl orthosilicate.

8. The process of claim 1, wherein the tetraalkyl orthosilicate is tetramethyl orthosilicate, tetraethyl orthosilicate, tetrapropyl orthosilicate, or tetrabutyl orthosilicate.

9. The process of claim 3, wherein the organosilane is a mono-alkylsilane; a di-alkylsilane; a trialkylsilane; an alkoxysilane; an aminoalkoxysilane; an ester-containing silane; or a polyalkoxysilane.

10. A modified zinc oxide nanoparticle soluble in an organic solvent, the nanoparticle comprising:
a Si—O-alkyl group,
wherein the nanoparticle is obtained by reacting a zinc oxide nanoparticle dissolved in a solvent with a tetraalkyl orthosilicate, and optionally with an organosilane, in the presence of ammonia or an amine,
wherein a water content of a reaction mixture for reacting the zinc oxide nanoparticle is less than 5% by weight, based on a total amount of solvent and water.

11. A formulation, comprising:
the modified ZnO nanoparticle of claim 10.

12. An inanimate organic material, comprising:
the modified ZnO nanoparticle of claim 10.

13. The material of claim 12, wherein the material is a plastic or a coating.

14. A sheet or film molding comprising the material of claim 13, wherein the material is a plastic.

15. A packaging material or automobile construction material, comprising the sheet or film molding of claim 14.

16. A UV absorber for an inanimate organic material, comprising the modified zinc oxide nanoparticle of claim 10.

17. A stabilizer for an inanimate organic material, comprising the modified zinc oxide nanoparticle of claim 10.

18. (canceled)

19. (canceled)

20. A method of stabilizing an inanimate organic material against an effect of light, a free radical, heat, or a combination thereof, the method comprising:
adding the modified ZnO nanoparticle of claim 10 to the material,
wherein the modified ZnO nanoparticle optionally comprises a UV absorber, a stabilizer, or a combination thereof as a further additive.

21. An inanimate organic material as a plastic, coating, or paint, comprising a UV absorber, stabilizer, or both a UV absorber and stabilizer which comprises the modified zinc oxide nanoparticle of claim 10.

22. A sheet or film comprising the material of claim 21 as a plastic.
